(19) United States
(12) Patent Application Publication
(10) Pub. No.: US 2007/0117907 A1
(43) Pub. Date: May 24, 2007

(54) Use of polyolefin waxes in hot melt compositions

(75) Inventors: Sebastijan Bach, Langweid (DE); Hans-Friedrich Herrmann, Gross-Gerau (DE); Gerd Hohner, Gersthofen (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant Produkte (Deutschland) GmbH

(21) Appl. No.: 11/601,473

(22) Filed: Nov. 17, 2006

(30) Foreign Application Priority Data
Nov. 18, 2005 (DE) 10 2005 055 019.3

(51) Int. Cl. C08K 5/01

(52) U.S. Cl. 524/487

(57) ABSTRACT

The invention relates to hot melt compositions based on isotactic, low molecular mass, low viscosity homopolymer or copolymer waxes and atactic polyalpha-olefins (APAOs). Hot melt compositions of this kind can be used with outstanding effect as hot melt adhesives.

The present invention is described in the German priority application No. 102005055019.3, filed 18 Nov. 2005, which is hereby incorporated by reference as is fully disclosed herein.

The invention relates to hot melt compositions based on isotactic, low molecular mass, low viscosity homopolymer or copolymer waxes and atactic polyalpha-olefins (APAOs).

Hot melt compositions or hot melts are thermoplastic materials which are solid at ambient temperature and in the liquid melt state are applied layerwise to suitable substrate surfaces where, following solidification, they exert different functions. They are constructed preferably on the basis of resins, waxes, thermoplastics, and elastomers, and may optionally also include additions of fillers, pigments, and additives such as stabilizers, etc.

By way of example, hot melt compositions can be used as solvent-free adhesives for bonding. On account of their multifarious advantages, hot melt adhesives of this kind are increasingly being used in the production of products including hygiene articles and care articles and also in the paper, packaging, furniture, textiles, footwear, and construction industries as an economic and eco-friendly alternative to conventional, solvent-based adhesives.

Hot melt compositions are further used in road construction as thermoplastic binders for producing visual traffic guidance marks, such as “zebra stripes” at pedestrian crossings, center lines or boundary lines, or other signal indications for controlling traffic flow. Besides waxes, the binders employed for this purpose may comprise thermoplastics, resins, and plasticizers. For roadmarking application these binders are generally blended with fillers such as sand or lime, pigments such as titanium dioxide, and light-reflecting additions, e.g., glass beads.

Constituents of typical hot melt adhesive formulas are polar and apolar polymers, resins, and waxes. The bond strength, which derives from the remanent, post-solidification adhesiveness of a pressure sensitive hot melt adhesive, depends on the one hand on the interaction of the adhesive with the substrate to which bonding is to take place, i.e., on the adhesion between pressure sensitive hot melt adhesive and substrate. In addition, however, the bond strength is also based on the cohesion (internal strength) of the pressure sensitive hot melt adhesive itself.

The polar and apolar polymers of the pressure sensitive hot melt adhesive serve as scaffold material. They ensure the cohesion of the adhesive and at the same time contribute to adhesion to the substrate. The resin addition enhances the adhesion and may promote compatibility between the various components of the adhesive. Waxes are used for modification in fractions, based on the weight of the hot melt adhesive compositions, of generally less than 10% by weight. They regulate important physical properties of the adhesives, such as hardness, melt viscosity, and softening point, and, in their effect on open time, adhesion, cohesion, etc., they decisively influence the performance characteristics. Use of wax in amounts of more than 10% by weight, however, has generally been found to date to be accompanied by a deterioration in the properties, particularly a reduction in the bond strength of the hot melt adhesive.

EP 0 890 584 claims the preparation of homopropylene waxes and propylene copolymer waxes by means of metallocene catalysts, and their use in hot melt compositions, among other systems. The hot melt compositions contain essentially three components: a polymer, an adhesive component (tackifier), and a wax.

WO 2004/104128 claims hot melt compositions containing as polyolefin waxes copolymer waxes of propylene, 0.1% to 30% by weight of ethylene, and 0.1% to 50% by weight of a branched or unbranched 1-alkene having 4 to 20 carbon atoms.

U.S. Pat. No. 5,397,843 describes hot melt compositions comprising high molecular mass ethylene-alpha-olefin copolymers and low molecular mass atactic polyalpha-olefins (APAOs).

U.S. 2004/0 115 456 and U.S. 2004/0 081 795 describe hot melt compositions containing 4% to 50% by weight of isotactic propylene copolymers and 20% to 65% by weight of an adhesive component (tackifier), examples being hydrocarbon resins, natural and modified resins, resin esters, and synthetic polyterpenes, and also, optionally, atactic polyalpha-olefins (APAOs), plasticizers, wax, stabilizers, filler material, and, optionally, a secondary polymer, examples being poly(meth)acrylates, etc. The hot melt composition examples contained in the two specifications comprise isotactic propylene copolymers with 1.5% to 20% by weight of ethylene or higher alpha-olefins, the copolymers having average molar masses M_{w} of between about 170 000 and 240 000 g/mol and number-average molar masses Mₙ of between about 60 000 and 80 000 g/mol. High molecular mass olefin polymers are, however, plastic-like, of high viscosity to solid, and show little, if any, adhesion. The hot melt compositions claimed in U.S. 2004/0 115 456 and U.S. 2004/0 081 795 contain, as well as isotactic propylene copolymers, 20% to 65% by weight of a tackifier. The use of such large amounts of tackifiers can, however, lead easily to corrosion, odor, and an adverse effect on operations of recycling the products provided with the hot melt compositions.

Suitable processing viscosities, sufficiently good initial adhesion, cohesion, adhesion to different surface materials, low-temperature and high-temperature stability are important quality criteria for the application of hot melt compositions, but so is a sufficient measure of flexibility, tensile load and stretching load to which composite material and adhesive connection are subjected over a long period of time in their specified end use.

It was an object of the present invention to provide hot melt compositions which satisfy the very different performance requirements imposed on hot melt compositions in respect of adhesion, cohesion, melt viscosity, temperature stability, etc., which can be formulated and handled well, which can be provided cost-effectively under economic conditions and which do not have the abovementioned disadvantages.

Completely surprisingly it has been found that this object is achieved through a combination of isotactic, low molecular mass, low-viscosity homopolymer or copolymer waxes with atactic polyalpha-olefins (APAOs).

Mixtures of atactic polyalpha-olefins (APAOs) and isotactic, low molecular mass, low-viscosity homopolymer or copolymer waxes have a viscosity of 500 mPa s to 10 000 mPa·s, preferably between 1000 and 5000 mPa·s, and can be applied easily to surfaces and exhibit very good cohesion.

The invention provides hot melt compositions comprising
a) 1% to 99% by weight of one or more isotactic homopolymer and/or copolymer waxes comprising the monomers ethylene and/or propylene and/or higher linear or branched alpha-olefins having 4 to 20 carbon atoms, the copolymer wax or waxes, based on the total weight of the copolymer wax or waxes, containing 0.1% to 30% by weight of structural units originating from one monomer and 70% to 99.9% by weight of structural units from the other monomer or monomers, and the homopolymer and copolymer wax(es) possessing a weight-average molecular weight M_{w} of less than or equal to 40 000 g/mol, having been obtained by metallocene catalysis, having a dropping point or ring & ball softening point of between 80 and 165° C., possessing a melt viscosity, measured at a temperature of 170° C., of between 20 and 40 000 mPa·s, and having a glass transition temperature, T_{g}, of not more than −20° C., and
b) 1% to 99% by weight of one or more amorphous, atactic polyalpha-olefins (APAOs).

The invention preferably provides hot melt compositions comprising
a) one or more isotactic homopolymer and/or copolymer waxes comprising the monomers ethylene and/or propylene, the copolymer waxes, based on the total weight of the copolymer waxes, containing 0.1% to 30% by weight of structural units originating from one monomer and 70% to 99.9% by weight of structural units from the other monomer.

Hot melt compositions further preferred in accordance with the invention comprise
a) one or more isotactic propylene homopolymer waxes and/or propylene copolymer waxes, the propylene copolymer waxes, based on the total weight of the copolymer waxes, containing 0.1% to 30% by weight of structural units from ethylene and 70% to 99.9% by weight of structural units from propylene.

In a further preferred embodiment of the invention the polyolefin waxes present in the hot melt compositions are copolymer waxes from ethylene and at least one branched or unbranched 1-alkene having 3 to 20 carbon atoms, the content of structural units from the branched or unbranched 1-alkenes having 3 to 20 carbon atoms in the copolymer waxes being in the range from 0.1% to 30% by weight.

In a further preferred embodiment of the invention the polyolefin waxes present in the hot melt compositions are copolymer waxes of propylene and one or more further monomers selected from ethylene and branched or unbranched 1-alkenes having 4 to 20 carbon atoms, the ethylene content of the copolymer waxes being in the range from 0.1% to 30% by weight and the amount of structural units from branched or unbranched 1-alkenes having 4 to 20 carbon atoms in the copolymer waxes being in the range from 0.1% to 50% by weight.

Hot melt compositions of the invention which are further preferred comprise homopolymer and/or copolymer waxes which have a number-average molar mass Mₙ of between 500 and 20 000 g/mol, preferably between 800 and 10 000 g/mol, more preferably between 1000 and 5000 g/mol, and a weight-average molar mass M_{w} of between 1000 and 40 000 g/mol, preferably between 1600 and 30 000 g/mol, and more preferably between 2000 and 25 000 g/mol.

The atactic polyalpha-olefins (APAOs) used in accordance with the invention in hot melt compositions are predominantly amorphous and have a crystallinity of less than 30%, determined by DSC (differential scanning calorimetry). The APAOs employed may be homopolymers of propylene or copolymers of propylene with one or more alpha-olefins, examples being ethylene, 1-butene, 1-propene, 1-hexene, 1-heptene, and 1-octene. The weight-average molar mass M_{w} of the APAOs employed is in the range from 4000 to 150 000 g/mol, preferably between 10 000 and 100 000 g/mol. Their softening points are between 80 and 170° C., their glass transition temperature T_{g} between −5° C. and −40° C.

Among the APAOs it is preferred to use propylene homopolymers, propylene-ethylene copolymers, propylene-1-butene copolymers, and propylene-ethylene-1-butene terpolymers. APAO polymers are obtainable under the trade names ®Eastoflex from Eastman Chemical Company, under the trade names ®Rextac from Huntsman Corporation or under the trade name ®Vestoplast from Degussa Corporation.

In one preferred embodiment the hot melt compositions of the invention comprise
a) 1% to 98% by weight, preferably 5% to 80% by weight, more preferably 10% to 70% by weight, and most preferably 20% to 60% by weight, of one or more of the above-described isotactic homopolymer and/or copolymer waxes, and
b) 1% to 98% by weight, preferably 10% to 80% by weight, more preferably 20% to 70% by weight, and most preferably 30% to 60% by weight of one or more amorphous, atactic polyalpha-olefins (APAOs).

In a further preferred embodiment the hot melt compositions of the invention comprise
a) 1% to 98% by weight, preferably 5% to 80% by weight, more preferably 10% to 70% by weight, and most preferably 20% to 60% by weight of one or more isotactic homopolymer and/or copolymer waxes comprising the monomers ethylene and/or propylene and/or higher linear or branched alpha-olefins having 4 to 20 carbon atoms, the copolymer wax or waxes, based on the total weight of the copolymer waxes, containing 0.1% to 30% by weight of structural units originating from one monomer and 70% to 99.9% by weight of structural units from the linear or branched monomer or monomers.

In a further preferred embodiment the hot melt compositions of the invention additionally comprise an amount of 0.1% to 35% by weight, preferably 5% to 30% by weight, more preferably 10% to 20% by weight, and most preferably 12% to 18% by weight, of a resin.

Resins available are aliphatic and cycloaliphatic hydrocarbons having softening points of 10° C. to 160° C., determined by ASTM method E28-58T. They may be prepared by polymerizing aliphatic and/or cycloaliphatic monomers. Likewise suitable are hydrogenated aliphatic and cycloaliphatic hydrocarbons.

The hot melt compositions of the invention may further comprise polyolefin polymers, waxes, plasticizers, polar or apolar polymers, pigments, fillers, stabilizers and/or antioxidants.

The polyolefin waxes used in accordance with the invention are prepared using metallocene compounds of the formula I.

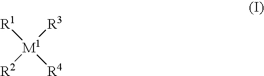

This formula also embraces compounds of the formula Ia 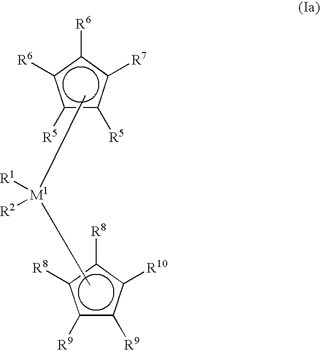
of the formula Ib 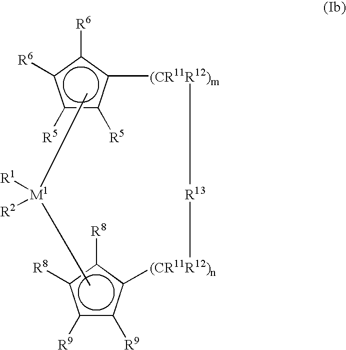
and of the formula Ic

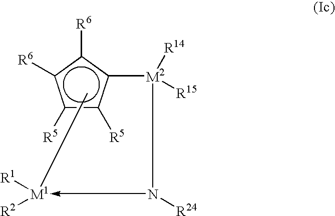

In formulae I, Ia and Ib, M¹ is a metal from group IVb, Vb or VIb of the periodic system, examples being titanium, zirconium, hafnium, vanadium, niobium, tantalum, chromium, molybdenum, and tungsten, preferably titanium, zirconium or hafnium.

R¹ and R² are identical or different and are a hydrogen atom, a C₁-C₁₀, preferably C₁-C₃ alkyl group, especially methyl, a C₁-C₁₀, preferably C₁-C₃ alkoxy group, a C₆-C₁₀, preferably C₆-C₈ aryl group, a C₆-C₁₀, preferably C₆-C₈ aryloxy group, a C₂-C₁₀, preferably C₂-C₄ alkenyl group, a C₇-C₄₀, preferably C₇-C₁₀ arylalkyl group, a C₇-C₄₀, preferably C₇-C₁₂ alkylaryl group, a C₈-C₄₀, preferably C₈-C₁₂ arylalkenyl group, or a halogen atom, preferably chlorine atom.

R³ and R⁴ are identical or different and are a mononuclear or polynuclear hydrocarbon radical which together with the central atom M¹ may form a sandwich structure. Preferably R³ and R⁴ are cyclopentadienyl, indenyl, tetrahydroindenyl, benzoindenyl or fluorenyl, it being possible for the parent structures to carry additional substituents or to be bridged with one another. It is also possible for one of the radicals R³ and R⁴ to be a substituted nitrogen atom, with R²⁴ having the definition of R¹⁷ and being preferably methyl, tert-butyl or cyclohexyl.

R⁵, R⁶, R⁷, R⁸, R⁹, and R¹⁰ are identical or different and are a hydrogen atom, a halogen atom, preferably a fluorine, chlorine or bromine atom, a C₁-C₁₀, preferably C₁-C₄ alkyl group, a C₆-C₁₀, preferably C₆-C₈ aryl group, a C₁-C₁₀, preferably C₁-C₃ alkoxy group, a radical —NR¹⁶₂—, —SR¹⁶—, —OSiR¹⁶₃—, —SiR¹⁶₃— or —PR¹⁶₂—, in which R¹⁶ is a C₁-C₁₀, preferably C₁-C₃ alkyl group or C₆-C₁₀, preferably C₆-C₈ aryl group or else, in the case of radicals containing Si or P, is a halogen atom, preferably chlorine atom, or pairs of adjacent radicals R⁵, R⁶, R⁷, R⁸, R⁹, or R¹⁰ form a ring with the carbon atoms connecting them. Particularly preferred ligands are the substituted compounds of the parent structures cyclopentadienyl, indenyl, tetrahydroindenyl, benzoindenyl or fluorenyl. 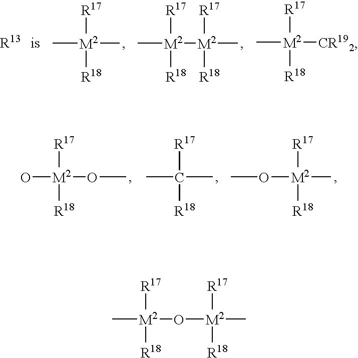
═BR¹⁷, ═AlR¹⁷, —Ge—, —Sn—, —O—, —S—, ═SO, ═SO₂, ═NR¹⁷, ═CO, ═PR¹⁷ or ═P(O)R¹⁷, R¹⁷, R¹⁸, and R¹⁹ being identical or different and being a hydrogen atom, a halogen atom, preferably a fluorine, chlorine or bromine atom, a C₁-C₃₀, preferably C₁-C₄ alkyl, especially methyl, group, a C₁-C₁₀ fluoroalkyl, preferably CF₃ group, a C₆-C₁₀ fluoroaryl, preferably pentafluorophenyl group, a C₆-C₁₀, preferably C₆-C₈ aryl group, a C₁-C₁₀, preferably C₁-C₄ alkoxy, especially methoxy group, a C₂-C₁₀, preferably C₂-C₄ alkenyl group, a C₇-C₄₀, preferably C₇-C₁₀ aralkyl group, a C₈-C₄₀, preferably C₈-C₁₂ arylalkenyl group or a C₇-C₄₀, preferably C₇-C₁₂ alkylaryl group, or R¹⁷ and R¹⁸, or R¹⁷ and R¹⁹, each form a ring together with the atoms connecting them.

M² is silicon, germanium or tin, preferably silicon and germanium. R¹³ is preferably ═CR¹⁷R¹⁸, ═SiR¹⁷R¹⁸, ═GeR¹⁷R¹⁸, —O—, —S—, ═SO, ═PR¹⁷ or ═P(O)R¹⁷.

R¹¹ and R¹² are identical or different and have the definition stated for R¹⁷. m and n are identical or different and denote zero, 1 or 2, preferably zero or 1, with m plus n being zero, 1 or 2, preferably zero or 1.

R¹⁴ and R¹⁵ have the definition of R¹⁷ and R¹⁸.

Examples of suitable metallocenes are:

bis(1,2,3-trimethylcyclopentadienyl)zirconium dichloride,

bis(1,2,4-trimethylcyclopentadienyl)zirconium dichloride,

bis(1,2-dimethylcyclopentadienyl)zirconium dichloride,

bis(1,3-dimethylcyclopentadienyl)zirconium dichloride,

bis(1-methylindenyl)zirconium dichloride,

bis(1-n-butyl-3-methylcyclopentadienyl)zirconium dichloride,

bis(2-methyl-4,6-diisopropylindenyl)zirconium dichloride,

bis(2-methylindenyl)zirconium dichloride,

bis(4-methylindenyl)zirconium dichloride,

bis(5-methylindenyl)zirconium dichloride,

bis(alkylcyclopentadienyl)zirconium dichloride,

bis(alkylindenyl)zirconium dichloride,

bis(cyclopentadienyl)zirconium dichloride,

bis(indenyl)zirconium dichloride,

bis(methylcyclopentadienyl)zirconium dichloride,

bis(n-butylcyclopentadienyl)zirconium dichloride,

bis(octadecylcyclopentadienyl)zirconium dichloride,

bis(pentamethylcyclopentadienyl)zirconium dichloride,

bis(trimethylsilylcyclopentadienyl)zirconium dichloride,

biscyclopentadienylzirconium dibenzyl,

biscyclopentadienylzirconium dimethyl,

bistetrahydroindenylzirconium dichloride,

dimethylsilyl-9-fluorenylcyclopentadienylzirconium dichloride,

dimethylsilylbis-1-(2,3,5-trimethylcyclopentadienyl)zirconium dichloride,

dimethylsilylbis-1-(2,4-dimethylcyclopentadienyl)zirconium dichloride,

dimethylsilylbis-1-(2-methyl-4,5-benzoindenyl)zirconium dichloride,

dimethylsilylbis-1-(2-methyl-4-ethylindenyl)zirconium dichloride,

dimethylsilylbis-1-(2-methyl-4-isopropylindenyl)zirconium dichloride,

dimethylsilylbis-1-(2-methyl-4-phenylindenyl)zirconium dichloride,

dimethylsilylbis-1-(2-methylindenyl)zirconium dichloride,

dimethylsilylbis-1-(2-methyltetrahydroindenyl)zirconium dichloride,

dimethylsilylbis-1-indenylzirconium dichloride,

dimethylsilylbis-1-indenylzirconium dimethyl,

dimethylsilylbis-1-tetrahydroindenylzirconium dichloride,

diphenylmethylene-9-fluorenylcyclopentadienylzirconium dichloride,

diphenylsilylbis-1-indenylzirconium dichloride,

ethylenebis-1-(2-methyl-4,5-benzoindenyl)zirconium dichloride,

ethylenebis-1-(2-methyl-4-phenylindenyl)zirconium dichloride,

ethylenbis-1-(2-methyltetrahydroindenyl)zirconium dichloride,

ethylenebis-1-(4,7-dimethylindenyl)zirconium dichloride,

ethylenebis-1-indenylzirconium dichloride,

ethylenebis-1-tetrahydroindenylzirconium dichloride,

indenylcyclopentadienylzirconium dichloride

isopropylidene(1-indenyl)(cyclopentadienyl)zirconium dichloride,

isopropylidene(9-fluorenyl)(cyclopentadienyl)zirconium dichloride,

phenylmethylsilylbis-1-(2-methylindenyl)zirconium dichloride,

and the alkyl or aryl derivatives of each of these metallocene dichlorides.

The single-center catalyst systems are activated using suitable cocatalysts. Suitable cocatalysts for metallocenes of the formula I are organoaluminum compounds, especially aluminoxanes, or else aluminum-free systems such as R²⁰ₓNH₄₋ₓBR²¹₄, R²⁰ₓPH₄₋ₓBR²¹₄, R²⁰₃CBR21₄ or BR²¹₃. In these formulae x is a number from 1 to 4, the radicals R²⁰ are identical or different, preferably identical, and are C₁-C₁₀ alkyl or C₆-C₁₈ aryl, or two radicals R²⁰ form a ring together with the atom connecting them, and the radicals R²¹ are identical or different, preferably identical, and are C₆-C₁₈ aryl which may be substituted by alkyl, haloalkyl or fluorine. In particular R²⁰ is ethyl, propyl, butyl or phenyl and R²¹ is phenyl, pentafluorophenyl, 3,5-bistrifluoro-methylphenyl, mesityl, xylyl or tolyl.

Additionally a third component is often necessary in order to maintain protection against polar catalyst poisons. Suitable for this purpose are organoaluminum compounds such as triethylaluminum, tributylaluminum, etc., and also mixtures.

Depending on process it is also possible for supported single-center catalysts to be used. Preference is given to catalyst systems in which the residual amounts of support material and cocatalyst do not exceed a concentration of 100 ppm in the product.

The invention further provides for the use of the hot melt compositions of the invention as hot melt adhesives.

Further possible constituents are resins, waxes, and apolar or polar polymers such as, for example, ethylene-vinyl acetate copolymers, polyacrylates, polyesters, polyethers, polycarbonates, polyacetals, polyurethanes, polyolefins, and rubber polymers, such as nitrile or styrene/butadiene rubbers.

Polyisobutylene, styrene-butadiene-styrene block polymers or styrene-isoprene-styrene block polymers, and, for particularly heavy-duty bonds, polyamides or polyesters. Examples of resin components which may be present include rosins and their derivatives or hydrocarbon resins, while possible waxes are hydrocarbon waxes such as Fischer-Tropsch paraffins, and polyolefin waxes not prepared using metallocene catalysts, it being possible for said waxes to have undergone apolar or polar modification, by means, for example, of oxidation or of grafting with polar monomers such as maleic anhydride. The hot melt adhesive compositions may further comprise fillers or auxiliaries such as plasticizers, pigments, and stabilizers, such as antioxidants or light stabilizers.

The examples which follow are intended to illustrate the invention to the person skilled in the art but not to restrict it to specific embodiments.

The melt viscosities were determined in accordance with DIN 53019 using a rotational viscometer, the dropping points in accordance with DIN 51801/2, the ring & ball softening points in accordance with DIN EN 1427. The weight-average molar mass M_{w}, the number-average molar mass Mₙ, and the resulting quotient M_{w}/Mₙ were determined by gel permeation chromatography at 135° C. in 1,2-dichlorobenzene.

The metallocene-polyolefin waxes 3 and 6 listed in Table 1 and employed in accordance with the invention have been prepared by polymerization of propylene or copolymerization of propylene with ethylene in the presence of the metallocene dimethylsilylbisindenylzirkoniumdichloride as catalyst pursuant to the general procedure described in EP 384 264 (see examples 1 to 16). The differences in softening points and viscosities resulted from variations in the ethylene supply and different polymerization temperatures.

TABLE 1
Composition of polyolefin waxes

| Polyolefin | Ethylene [% by | Propylene [% by |
|---|---|---|
| wax | weight] | weight] |
| 3 | 9 | 91 |
| 6 | 0 | 100 |

TABLE 2
Softening/dropping point, viscosity, weight-average
molecular weights, and density of polyolefin waxes

| | | | | Weight- | |
|---|---|---|---|---|---|
| | | Softening/ | | average | |
| | | dropping | Viscosity | molecular | |
| | | point | at 170° C. | weight M_{w} | Density |
| | Product type | [° C.] | [mPa · s] | [g/mol] | [g/cm³] |
| 3 | Propylene-ethylene | 92** | 1600 | 13 300 | 0.88 |
| | copolymer wax | | | | |
| | (metallocene) | | | | |
| 6 | Propylene | 148* | 130 | 4600 | 0.90 |
| | homopolymer wax | | | | |
| | (metallocene) | | | | |

*Dropping point
**Softening point

Performance Results

TABLE 3
Melt viscosities and cohesions of hot melt adhesives in
comparison to individual components

| | | | Cohesion |
|---|---|---|---|
| 3 | 6 | Vestoplast 703 | [N/mm²] |
| | | 100% by wt. | 1.1 |
| 100% by wt. | | | 1.1 |
| 55% by wt. | | 45% by wt. | 3.5 |
| | 100% by wt. | | cannot be measured |
| | 55% by wt. | 45% by wt. | 4 |

The hot melt adhesive compositions listed in Table 3 were prepared from the copolymer waxes 3 and 6 indicated in Table 1, and the atactic alpha-olefins (APAOs) available under the trade name Vestoplast 703 (Degussa) in the mixing proportions given in Table 3 for APAO and homopolymer or copolymer waxes. The components were jointly melted and stirred at 180° C. for a period of 1 h.

The melt viscosities of the hot melt adhesive compositions at 170° C. were determined in accordance with DIN 53019 using a rotational viscometer; the cohesions were determined in accordance with DIN 53455 by casting moldings and testing their mechanical stability in a tensile test.

1. A hot melt composition comprising
a) 1% to 99% by weight of one or more isotactic homopolymer waxes, isotactic copolymer waxes or a mixture thereof, the one or more waxes comprising the monomers ethylene propylene, higher linear or branched alpha-olefins having 4 to 20 carbon atoms or a combination thereof, the one or more waxes, based on the total weight of the one or more waxes, containing 0.1% to 30% by weight of structural units originating from one monomer and 70% to 99.9% by weight of structural units from the other monomer or monomers, wherein the one or more waxes have a weight-average molecular weight M_{w} of less than or equal to 40 000 g/mol, are obtained by metallocene catalysis, have a dropping point or ring & ball softening point of between 80 and 165° C., have a melt viscosity, measured at a temperature of 170° C., of between 20 and 40 000 mPa·s, and have a glass transition temperature, T_{g}, of not more than −20° C., and
b) 1% to 99% by weight of one or more amorphous, atactic polyalpha-olefins.

2. The hot melt composition as claimed in claim 1, comprising
a) one or more isotactic propylene homopolymer waxes isotactic propylene copolymer waxes or a mixture thereof, the one or more waxes, based on the total weight of the one or more waxes, containing 0.1% to 30% by weight of structural units from ethylene and 70% to 99.9% by weight of structural units from propylene.

3. The hot melt composition as claimed in claim 1, wherein the one or more waxes comprise ethylene and at least one branched or unbranched 1-alkene having 3 to 20 carbon atoms, the amount of structural units from the branched or unbranched 1-alkenes having 3 to 20 carbon atoms in the one or more waxes being in the range from 0.1% to 30% by weight.

4. The hot melt composition as claimed in claim 1, wherein the one or more waxes comprise at least one copolymer wax from propylene and one or more further monomers selected from the group consisting of ethylene and branched or unbranched 1-alkenes having 4 to 20 carbon atoms, the ethylene content of the one or more waxes being in the range from 0.1% to 30% by weight and the amount of structural units from branched or unbranched 1-alkenes having 4 to 20 carbon atoms in the one or more waxes being in the range from 0.1% to 50% by weight.

5. The hot melt composition as claimed in claim 1, wherein the one or more waxes have a number-average molar mass Mₙ of between 500 and 20 000 g/mol, and a weight-average molar mass M_{w} of between 1000 and 40 000 g/mol.

6. The hot melt composition as claimed in claim 1, wherein the one or more atactic polyalpha-olefins are predominantly amorphous, and possess a crystallinity of less than 30%, determined by differential scanning calorimetry.

7. The hot melt composition as claimed in claim 6, wherein the one or more atactic polyalpha-olefins are homopolymers of propylene or copolymers of propylene with one or more alpha-olefins.

8. The hot melt composition as claimed in claim 1, wherein the weight-average molar mass M_{w} of the one or more atactic polyalpha-olefins is in the range from 4000 to 150 000 g/mol, wherein the softening points are between 80 and 170° C., and the glass transition temperature T_{g} is between −5° C. and −40° C.

9. The hot melt composition as claimed in claim 1, comprising
a) from 1% to 98% by weight of the one or more waxes, and
b) from 1% to 98% by weight of the one or more amorphous atactic polyalpha-olefins.

10. The hot melt composition as claimed in claim 1, further comprising from 0.1% to 35% by weight of a resin.

11. A hot melt adhesive comprising a hot melt composition as claimed in claim 1.

12. The hot melt composition as claimed in claim 1, wherein the one or more waxes have a number-average molar mass Mₙ of between 800 and 10 000 g/mol and a weight-average molar mass M_{w} of between 1600 and 30 000 g/mol.

13. The hot melt composition as claimed in claim 1, wherein the one or more waxes have a number-average molar mass Mₙ of between 1000 and 5000 g/mol and a weight-average molar mass M_{w} of between 2000 and 25 000 g/mol.

14. The hot melt composition as claimed in claim 7, wherein the one or more alpha olefins are selected from the group consisting of ethylene, 1-butene, 1-propene, 1-hexane, 1-heptene and 1-octene.

15. The hot melt composition as claimed in claim 8, wherein the weight-average molar mass M_{w} of the one or more atactic polyalpha-olefins is in the range between 10 000 and 100 000 g/mol.
